(19) United States
(12) Patent Application Publication
(10) Pub. No.: US 2024/0256271 A1
(43) Pub. Date: Aug. 1, 2024

(54) GRAPHICAL USER INTERFACE ELEMENT FOR TRACKING DESIGN AND DEVELOPMENT CHANGES ACROSS MULTIPLE WEB-BASED APPLICATIONS

(71) Applicant: Salesforce, Inc., San Francisco, CA (US)

(72) Inventors: Ariana Escobar Casares, Madrid (ES); Brendan Gatens, Columbus, OH (US); Sanjana Seshadri, San Francisco, CA (US); Marcelino Llano, Madrid (ES)

(73) Assignee: Salesforce, Inc., San Francisco, CA (US)

(21) Appl. No.: 18/161,458

(22) Filed: Jan. 30, 2023

(51) Int. Cl. G06F 8/71; G06F 3/0482; G06F 3/0483; G06F 3/0484; G06F 8/20; G06F 8/77

(52) U.S. Cl. CPC G06F 8/71; G06F 3/0482; G06F 3/0483; G06F 3/0484; G06F 8/20; G06F 8/77

(57) ABSTRACT

A computing system tracks changes to software applications in a development environment. An embodiment of the system includes a processor and computer storage with executable instructions that cause the processor to perform operations including: permitting developer access to different web-based software applications in the development environment, wherein the applications are part of a defined development project; causing display of a GUI project bar, the GUI project bar having a counter arrangement that graphically tracks changes made to the applications in the development environment; and updating status of the counter arrangement in response to changes made to any of the applications in the development environment. Status of the counter arrangement is updatable within the development environment to maintain at least one running count of changes made to the applications.

### TECHNICAL FIELD

Embodiments of the subject matter described herein relate generally to the generation, control, and display of graphical user interface elements. More specifically, embodiments of the disclosed subject matter relate to a graphical user interface element that is maintained and controlled to indicate changes made to a plurality of different web-based software applications within a development environment.

### BACKGROUND

A software development environment can support the creation, design, and modification of one or more web-based software applications that are related to one another or are part of a defined development project. Indeed, many software solutions and systems can be implemented by integrating multiple web applications or products. As a result, it can be difficult for users (e.g., developers) to track changes between the multiple applications. The ongoing work being performed may lack visibility because the full “picture” may only be fully understood by one particular user. This can lead to many problems, such as inefficient communication, partial testing coverage, and failed deployments. Activity logs can help to some degree, but the core issue is that changes may reside in many different places (software applications), with no easy and convenient way to monitor, display, and act upon the changes as a cohesive group.

Accordingly, it is desirable to have a graphical tool that monitors and tracks changes across multiple web-based software applications or products, while a user is performing work within a development environment. To this end, certain desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified block diagram representation of an exemplary embodiment of a system that supports the design and development of web-based software applications;

FIG. 2 is a flow chart that illustrates an exemplary embodiment of a process for tracking changes across a plurality of web-based software applications;

FIG. 3 is a schematic representation of a portion of a web page displayed for a web-based software application under development;

FIG. 4 is a schematic representation of a GUI project bar in a first state;

FIG. 5 is a schematic representation of the GUI project bar in a second state;

FIG. 6 is a schematic representation of the GUI project bar in a third state;

FIG. 7 is a schematic representation of the GUI project bar in a fourth state;

FIG. 8 is a schematic representation of the GUI project bar in a fifth state;

FIG. 9 is a flow chart that illustrates an exemplary embodiment of a process for saving changes made to one or more web-based software applications;

FIG. 10 is a schematic representation of a Save Changes interface;

FIG. 11 is a flow chart that illustrates an exemplary embodiment of a process for discarding changes made to one or more web-based software applications;

FIG. 12 is a simplified block diagram representation of an exemplary embodiment of an electronic device; and

FIG. 13 is a simplified block diagram representation of an exemplary embodiment of a deployment environment.

### DETAILED DESCRIPTION

The subject matter presented here relates to a graphical user interface (GUI) feature (referred to herein as a “project bar”) that automatically tracks changes across a plurality of different web-based software applications. The GUI project bar can be generated for display with each application, as an overlay on each application, as an on-demand window or pop-up element associated with each application, or the like. In certain exemplary deployments, the GUI project bar is persistently displayed at or near the top of each page (for the different web applications). The project bar is updated in response to changes made to any of the web applications associated with a development project, giving the user a quick visual reference regardless of which page is currently in focus. The changes accumulated for one development project can therefore be treated as a single bundle that belongs to that particular project and to one developer/user. As the user makes changes in any one of the web applications that belong to the project, the GUI project bar is immediately updated for display with all of the other web applications in the project. This allows the user to save changes, run tests, and deploy everything at once, even if those changes reside in many different web-based software applications.

In accordance with certain embodiments, the GUI project bar is maintained and updated to graphically track changes made to multiple web-based applications, wherein the tracked changes are made by only one user within a development environment. In such embodiments, the GUI project bar is user-specific in that it is maintained and updated for a particular developer—even though a plurality of different users may have access to the web-based applications for purposes of collaborative development. In some embodiments, the GUI project bar monitors and tracks changes made by a plurality of different users, such that each developer/user has ongoing visibility of accumulated changes being made by other users.

In the context of this description, a change to a web-based software application may involve, without limitation: the creation/addition of something; the revision, modification, or updating of something that has already been created; or the deletion, removal, or replacement of something that has already been created. In the context of this description, a change to a web-based software application may apply to any of the following, without limitation: an active GUI element; a GUI panel; a functional module; a displayed feature, icon, or graphic; a hyperlink; a data entry field; software code; a list; a menu; a pop-up window; or any item, function, or feature supported by the web-based software application. Moreover, a change to a web-based software application may involve the re-arrangement of GUI elements, displayed features, or the like. In certain embodiments, a change to a web-based software application may be associated with metadata changes.

The user can navigate between the different web-based software applications within the development environment by interacting with active elements, links, button, and/or menu items that appear in connection with the various applications. In certain implementations, the various applications may include features and functionality that support cross-application navigation. In accordance with some embodiments, the GUI project bar includes features and functionality (e.g., selectable buttons or links) that enable the user to quickly and easily navigate between the applications within the development environment.

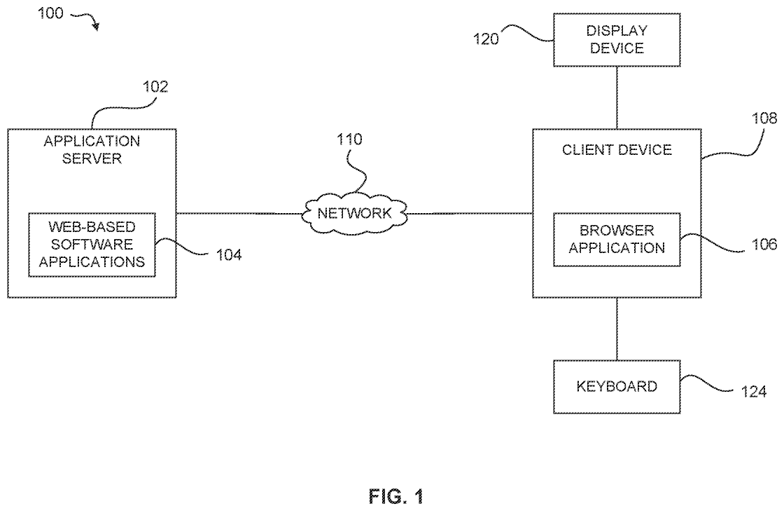

FIG. 1 is a simplified block diagram representation of an exemplary embodiment of a system 100 that supports the design and development of web-based software applications. It should be appreciated that FIG. 1 depicts a simplified representation of the system 100 for purposes of explanation and is not intended to be limiting. The system 100 includes an application server 102 that is configurable to provide instances of a plurality of different web-based software applications 104 within a client application (e.g., a web browser application 106) executed on a client device 108. The client device 108 is communicatively coupled to the application server 102 via a communication network 110, such as the Internet or any sort or combination of wired and/or wireless computer network, a cellular network, a mobile broadband network, a radio network, or the like. In one or more implementations, any of the web-based software applications 104 can be realized as a virtual application generated at run-time or on-demand. As described in greater detail below, the web browser application 106 allows a user to initiate and save changes to one or more of the web-based software applications 104 within a development environment. In such a scenario, the different web-based software applications 104 are related in that they are all part of a defined development project to which the user has access.

The client device 108 generally represents an electronic device coupled to the network 110 that may be utilized by a user to access the web-based software applications 104 provided by the application server 102. While working in the development environment, a user of the client device 108 can create, manipulate, edit, delete, and configure certain functions, elements, and features of the web-based software applications 104 via the browser application 106. In practice, the client device 108 can be realized as any sort of personal computer, mobile telephone, tablet, wearable device, vehicle-based component, smart medical device or appliance, or other network-enabled electronic device. In exemplary embodiments, the client device 108 includes or communicates with a display device 120, such as a monitor, screen, or another conventional electronic display, which is capable of graphically presenting data and/or information provided by the web-based software applications 104. More specifically, the display device 120 can be used to present web pages of the web-based software applications 104, which may include GUI panels, menus, links, data entry fields, UI elements, and the like. The client device 108 also includes or cooperates with at least one user input device, such as a physical or virtual keyboard 124, a touchscreen, a touch panel, a mouse, a joystick, a directional pad, a motion sensor, or the like, which is capable of receiving input from the user of the client device 108.

The client device 108 executes or otherwise supports the web browser application 106 (or any suitable client application) that communicates with the web-based software applications 104 on the application server 102 using a networking protocol. The client device 108 generally represents a computing device or platform having a combination of processing logic, circuitry, hardware, and/or other components configured to support the web browser application 106 and related GUI navigation processes, tasks, operations, and/or functions described herein. In this regard, the client device 108 generally includes a processing system, which may be implemented using, for example, one or more processors, central processing units (CPUs), controllers, microprocessors, microcontrollers, processing cores and/or other hardware computing resources configured to support the operation of the system described herein. The processing system may include or otherwise access a data storage element (or memory) capable of storing programming instructions for execution by the processing system. The instructions are configurable such that, when read and executed, they cause the processing system to provide instances of the web browser application 106.

The web browser application 106 is configured and operated to contact the application server 102 and/or the web-based software applications 104 using a networking protocol, such as the hypertext transport protocol (HTTP) or the like, to access or otherwise initiate instances of the web-based software applications 104 being presented on the client device 108 (e.g., by or within the web browser application 106).

The application server 102 generally represents a server computing device, server computing system or another combination of processing logic, circuitry, hardware, and/or other components configured to support the web-based software applications 104 and related processes, tasks, operations, and/or functions described herein. In this regard, the application server 102 generally includes a processing system, which may be implemented using, for example, one or more processors, central processing units (CPUs), controllers, microprocessors, microcontrollers, processing cores and/or other hardware computing resources configured to support the operation of the system described herein. The processing system may include or otherwise access a data storage element (or memory) capable of storing programming instructions for execution by the processing system. The instructions are configurable such that, when read and executed, they cause the processing system to create, generate, or otherwise facilitate an application platform that generates or otherwise provides instances of the web-based software applications 104 at run-time (or “on-demand”) based at least in part upon code and other data that is stored or otherwise maintained by the memory, a database, or another location on the network 110. Depending on the embodiment, the memory may be realized as a random access memory (RAM), read only memory (ROM), flash memory, magnetic or optical mass storage, or any other suitable non-transitory short or long term data storage or other computer-readable media, and/or any suitable combination thereof.

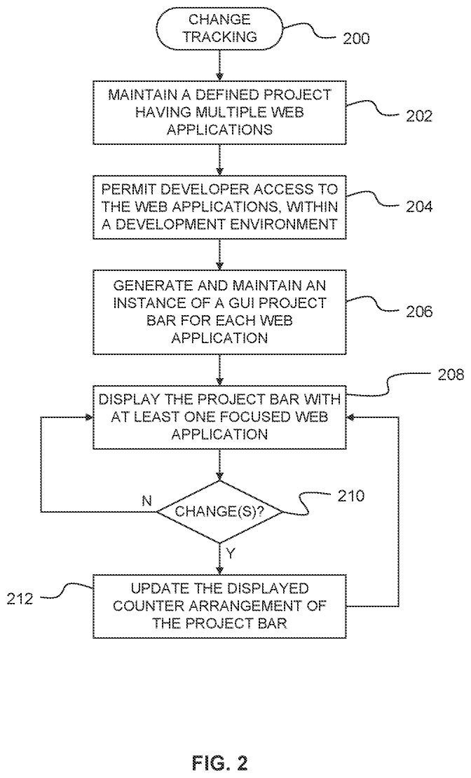

FIG. 2 is a flow chart that illustrates an exemplary embodiment of a change tracking process 200. The process 200 represents an embodiment of a method of tracking changes to software applications (e.g., web-based applications) in a development environment. The following description of the process 200 assumes that a plurality of different web-based software applications have already been created or initialized, and that those applications are part of a defined development project. Accordingly, one or more users (developers) may be tasked with modifying, testing, changing, and otherwise developing the suite of related applications as needed. To this end, the process 200 maintains a defined development project having multiple (and different) web-based software applications (task 202). In accordance with certain embodiments, the development environment supports the display of the different web-based software applications via a plurality of different web pages that can be navigated by authorized users.

The process 200 continues by permitting developer access to the different web-based software applications in the development environment (task 204). Task 204 may require the user to log in with appropriate credentials that allow the user to gain developer access to the applications (for example, by way of the web browser application 106 on the client device 108). Moreover, task 204 can permit developer access by multiple users to facilitate collaborative development. However, the development environment for each user can be an isolated workspace (e.g., a sandbox) that allows each user to make tentative changes to one or more applications before actually committing changes to the actual production environment.

The process 200 is performed to cause the display of a GUI project bar on at least one display device. In accordance with certain embodiments, the process 200 generates and maintains an instance of the GUI project bar in association with each of the web-based software applications that are included with the development project (task 206). To this end, the GUI project bar can be persistently displayed with some or all of the different web pages associated with the web-based software applications. Alternatively, the GUI project bar can be displayed in an on-demand manner for some or all of the different web pages associated with the web-based software applications. For example, any given web page may include an activatable control element (a link, a button, a menu item, etc.) that allows the user to show/hide the GUI project bar as desired. This description assumes that the GUI project bar is displayed with at least one focused web-based software application (task 208), such that the current user can view and manipulate the GUI project bar on the focused application.

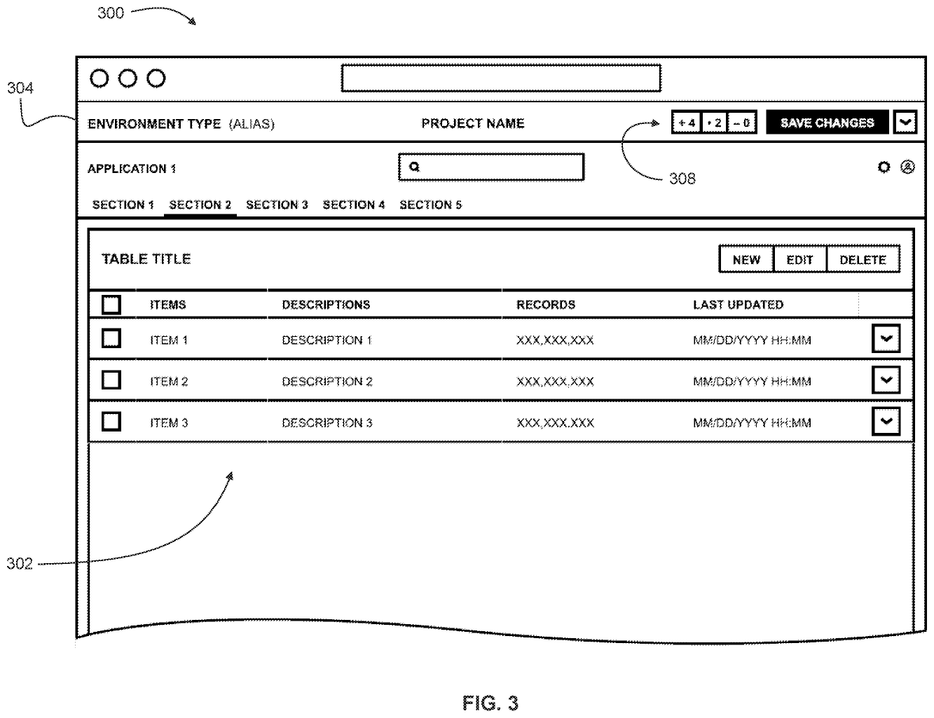

FIG. 3 is a schematic representation of a portion of a web page 300 displayed for a web-based software application 302 under development by a particular user. The content, purpose, functionality, and operation of the application 302 are unimportant for purposes of this description, and may vary or be customized from one use case to another. Moreover, the content, purpose, functionality, and operation of the different web-based software applications included with the development project need not be similar, equivalent, or functionally related to one another. The web pages and applications depicted here merely represent suitable examples that support the disclosed features.

The web page 300 includes (or is otherwise displayed with) an instance of a GUI project bar 304. The illustrated embodiment of the GUI project bar 304 is horizontally oriented, although other orientations, arrangements, shapes, sizes, and configurations are possible. FIG. 3 depicts the GUI project bar 304 in a current state for a particular moment in time, e.g., after some changes have been made to the application 302 and/or to one or more other applications associated with the same development project. An instance of the GUI project bar 304 can also be rendered with the web pages of the other applications contained in the same development project. In certain embodiments, the GUI project bar includes or is associated with a counter arrangement 308 that graphically tracks changes made to the plurality of different web-based software applications in the development environment. Notably, the appearance of the counter arrangement 308 is automatically updated in response to the completion of an eligible type of change made to any of the plurality of different web-based software applications in the development environment. Although various types and categories of changes can be monitored and tracked, the eligible changes contemplated by the exemplary embodiments described herein include additions, modifications, and deletions. It should be understood that alternative or additional types of changes can be monitored and tracked by an implementation of the counter arrangement 308.

Referring again to FIG. 2, if no eligible changes are detected (the “No” branch of query task 210), then the GUI project bar 304 remains displayed in its current form, without updating it. If, however, at least one eligible change is made to any of the applications in the development environment (the “Yes” branch of query task 210), then the process 200 continues by updating the status of the displayed counter arrangement 308 (task 212). In this regard, the status of the counter arrangement 308 is updatable within the development environment to maintain at least one running count of eligible changes made to the plurality of different web-based software applications. As depicted in FIG. 2, the process 200 may return to task 208 to display the updated version of the GUI project bar.

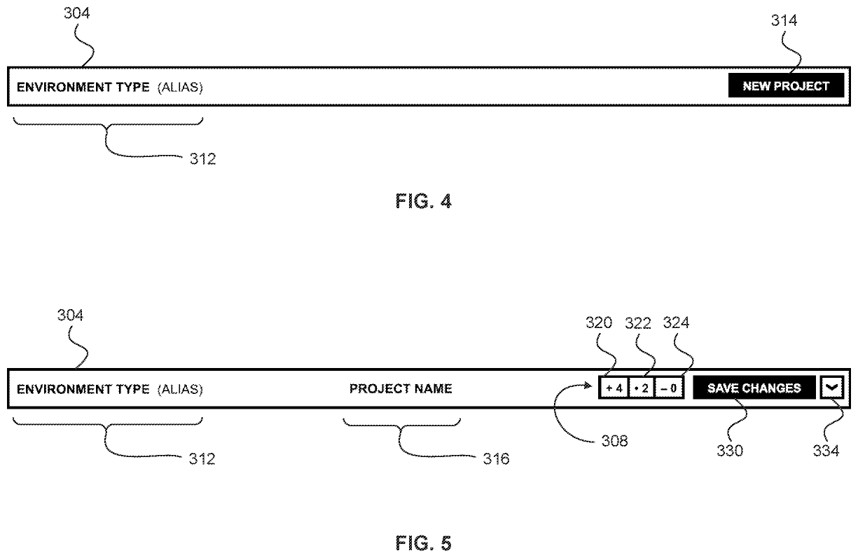

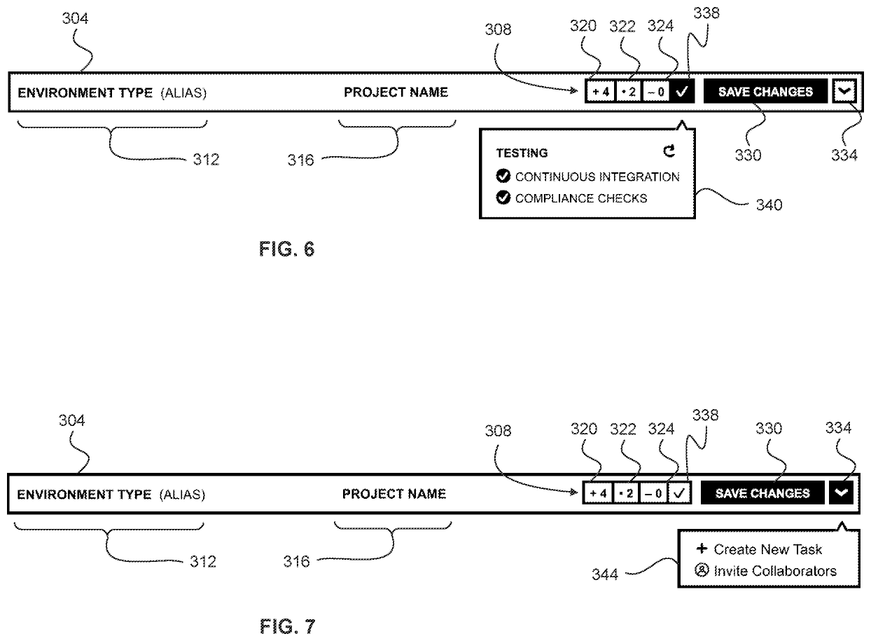

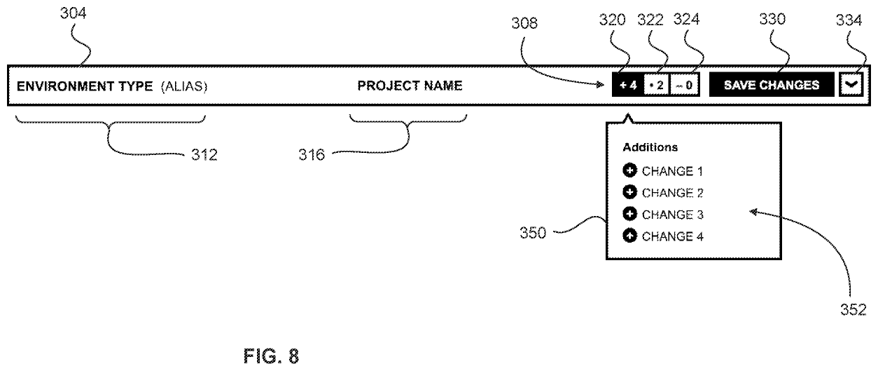

FIG. 3 depicts the GUI project bar 304 in one possible state. The GUI project bar 304 is dynamic in nature—the displayed content, features, and functionality can vary depending on the current status of the development environment, the current status of the development project, the current condition of the web-based software applications in the development environment, etc. FIGS. 4-8 are schematic representations of the GUI project bar 304 corresponding to different states. More specifically: FIG. 4 is a schematic representation of the GUI project bar 304 in a first state (before creation of a new development project); FIG. 5 is a schematic representation of the GUI project bar 304 in a second state (where some changes are pending); FIG. 6 is a schematic representation of the GUI project bar 304 in a third state (during/after testing); FIG. 7 is a schematic representation of the GUI project bar 304 in a fourth state (with more actions displayed); and FIG. 8 is a schematic representation of an embodiment of the GUI project bar 304 in a fifth state (with a list of changes provided in a window).

Referring to FIG. 4, the illustrated state of the GUI project bar 304 includes: an environment field 312 that identifies the current working environment; and an activatable New Project button 314 that can be activated by the user to create a new development project. For this particular example, the environment field 312 identifies the current working environment by its type and by its alias (if applicable). FIG. 5 depicts the GUI project bar 304 after a project has been created. The state of the GUI project bar 304 shown in FIG. 5 includes a project field 316 that identifies the name of the current development project. After creation of a project, the GUI project bar 304 is updated to include the counter arrangement 308. Although not always required, the depicted embodiment of the counter arrangement 308 includes, without limitation: an addition counter 320 that is updatable within the development environment to indicate a running count of additions made to the plurality of different web-based software applications; a modification counter 322 that is updatable within the development environment to indicate a running count of modifications made to the plurality of different web-based software applications; and a deletion counter 324 that is updatable within the development environment to indicate a running count of deletions made to the plurality of different web-based software applications. Accordingly, this particular counter arrangement 308 is utilized to monitor and track three eligible types of changes throughout the current development project: additions; modifications (e.g., updates, revisions, or edits); and deletions. Alternative embodiments may be designed and controlled to track alternative or additional types of changes, as applicable. As used herein, a change that is tracked and considered by the GUI project bar 304 may be associated with one or more items or elements of the web-based software applications included in the current development project. To this end, an eligible change may relate to any of the following, without limitation: a functional module; a feature; a component; an active GUI element; a menu item; a data entry field; a link; a displayed window; a sidebar; a panel; re-arrangement of one or more GUI elements or displayed features; metadata changes; or the like.

The individual counters of the counter arrangement 308 are updated to display the current accumulated totals across all of the multiple web-based software applications. Thus, the status of the counter arrangement 308 is updated immediately in response to the completion of any eligible change that is made to any of the web-based applications in the development environment. FIG. 5 depicts a state where four additions, two modifications, and no deletions have been completed. The individual counters are updated as needed to reflect the accumulated total number of additions, modifications, and deletions as those changes occur. If, for example, two deletions are made to one or more of the applications in the development environment, then the deletion counter 324 will be updated to indicate the number two, such that the updated counter arrangement 308 will display four, two, and two as the three counter values. If an item is subsequently added to any one of the applications in the development environment, then the addition counter 320 will be updated to indicate the number five, such that the updated counter arrangement 308 will display five, two, and two as the three counter values. Importantly, the same counter values are displayed as the user navigates between the different web-based software applications, such that the current accumulated changes remain visible regardless of the currently focused view. It is also possible to have multiple windows open, in one or more devices, to achieve enhanced visibility of the development environment. In such a scenario, the same displayed content and state of GUI project bar 304 are provided across the different windows, provided that the same user session is active. This functionality can be accomplished via websockets, polling, or any modern software that allows the system to display updates to the currently open web browser windows.

The illustrated version of the GUI project bar 304 also includes an activatable Save Changes element 330 (e.g., a selectable button) that can be activated by the user to initiate saving of one or more of the accumulated changes. The Save Changes element 330 need not be displayed in the state shown in FIG. 4 (i.e., before creation of a development project). The illustrated version of the GUI project bar 304 also includes an activatable More Actions button 334 that can be activated by the user to reveal a list, a window, a panel, an overlap, or any suitable GUI element that includes other actions, features, functions, or options that are available to the user. The Save Changes element 330 and the More Actions button 334 need not be displayed in the state shown in FIG. 4 (i.e., before creation of a development project). These features and related functionality are described in more detail below.

The development environment may support testing of the web-based software applications, e.g., automatic testing of completed changes. Such testing may be initiated in response to completion of a change, and may be performed in the background with little to no visibility. In this regard, FIG. 6 depicts the GUI project bar 304 in a state after completion of testing. The illustrated version of the GUI project bar 304 includes a Test Status button 338 (which may be an active button) that graphically indicates the current status of the background testing. FIG. 6 depicts a scenario after successful testing for Continuous Integration and Compliance Checks (alternative or additional test results can be displayed, as appropriate for the particular implementation, development environment, and applications under development). To this end, a test summary window 340 and/or any suitable GUI element can be generated and displayed automatically or on-demand to provide the test results. For example, the Test Status button 338 can be activated to display the test summary window 340. In certain embodiments, the Test Status button 338 is persistently displayed and is updated to indicate the current status. For example: a green checkmark can be displayed to indicate successful testing; a red “X” or other icon can be displayed to indicate a failed or problematic test result; and a spinning wheel, hourglass, clock, or other icon can be displayed to indicate that testing is in progress.

FIG. 7 depicts a state after activation of the More Actions button 334. In response to activation of the More Actions button 334, a window 344 and/or any suitable GUI element can be generated and displayed to provide a list of additional actions, options, features, or functions. The listed items may be provided as selectable items that can be activated on-demand by the user. The illustrated example shows two available actions: Create New Task; Invite Collaborators. Alternative or additional actions can be listed in the window 344 as appropriate for the particular implementation, development environment, and applications under development. For example, the More Actions button 334 can be designed as a launching point for discarding or reverting changes that have already been made to one or more of the web-based software applications.

In accordance with certain implementations, one or more of the individual counters can be generated and rendered as an active or selectable GUI element. As an example, FIG. 8 depicts the GUI project bar 304 with a displayed window 350 that is associated with the addition counter 320. The window 350 may appear in response to selection or activation of the addition counter 320. Alternatively or additionally, the window 350 may be displayed when a pointer, cursor, or a touch input is detected to be hovering over or within close proximity to the addition counter 320. The content displayed in the window 350 includes information related to the additions accumulated by the addition counter 320. In this regard, the displayed information may include, without limitation, a list of the changes (additions). Each entry in the list may include descriptive or identifying data associated with the respective change, e.g., name, functionality, type, location (the web-based software application and/or web page), time stamp, product, system, component. In certain embodiments, the window 350 displays a selectable list 352 of the accumulated changes. The selectable list 352 allows the user to select any or all of the listed changes for purposes of saving, discarding, showing additional details, or the like.

As mentioned above, the GUI project bar 304 maintains a running count of different types of changes that have been made within the user's development environment. Although such changes are effective within the user's development environment, additional action must be taken to save them outside of the development environment. In this regard, each change within the development environment may generate or update a suitably formatted change object, log file, metadata, temp file, or the like. This enables the system to preserve the information associated with the accumulated changes such that any of the changes can be subsequently implemented in the actual production environment. The preserved data/information may include defining values, characterizing data, timestamp information, and/or other information that identifies the type of change (addition, modification, deletion), the particular web-based application or product where the change was made, the specific component or module that is affected by the change, etc.

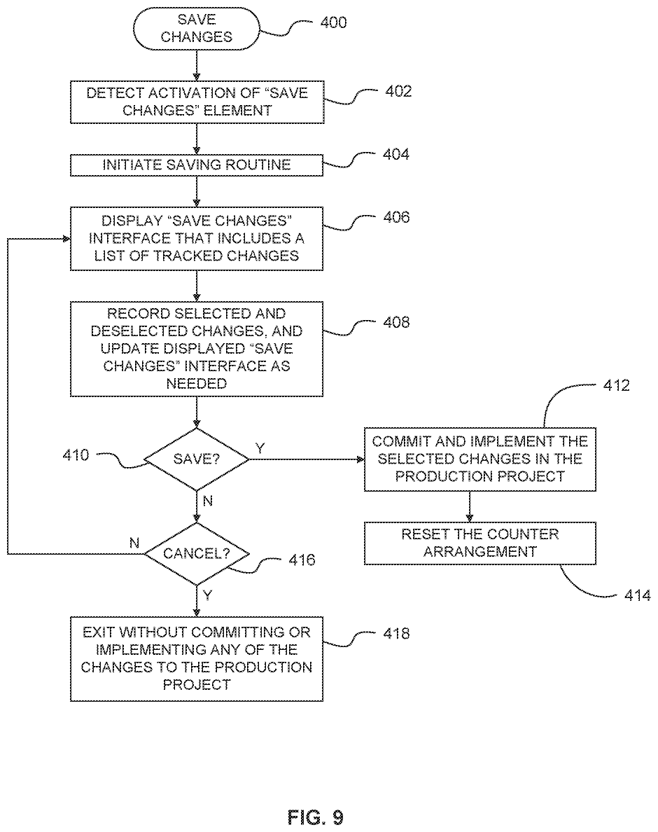

Referring to FIG. 9, an exemplary embodiment of a save changes process 400 is depicted. The process 400 can be performed to save changes made to one or more web-based software applications. The process 400 can be performed to implement and save one or more of the accumulated changes outside of the development environment. In other words, the process 400 can be utilized to save one or more of the changes in the defined production project that is associated with the development environment.

As described above with reference to FIGS. 5-8, the GUI project bar 304 may include an activatable Save Changes element 330 that, when activated, initiates saving of at least one change tracked by the counter arrangement 308. Alternatively or additionally, a Save Changes option may be provided in response to activation of the More Actions button 334. This description assumes that the process 400 detects activation of the Save Changes element 330 (task 402) and, in response to such detection, takes appropriate action to initiate a saving routine or procedure (task 404). In certain embodiments, activation of the Save Changes element 330 initiates the display of a suitably formatted and arranged Save Changes interface (task 406). The Save Changes interface may include a list of entries corresponding to the changes tracked by the counter arrangement 308.

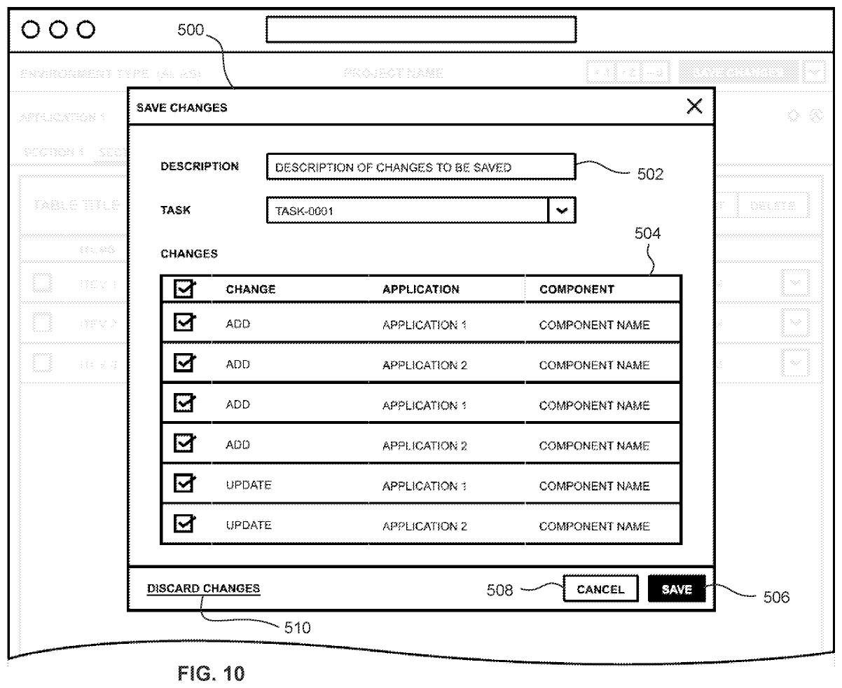

In some embodiments, the Save Changes interface can be generated and displayed as a pop-up list or window, similar to the window 350 shown in FIG. 8. In certain embodiments, the Save Changes interface is generated and displayed as a separate or overlay window to accommodate user interaction. For example, FIG. 10 depicts a suitable representation of a Save Changes interface 500 that is displayed in response to activation of the Save Changes element 330. The illustrated version of the Save Changes interface 500 includes a Description field 502 that allows the user enter text in association with the saved changes. The Save Changes interface 500 also includes a list 504 of the changes tracked by the GUI project bar 304, wherein at least some of the entries are selectable to identify changes to be implemented in the defined production project. Items in the list 504 may include descriptive or identifying data associated with the respective change, e.g., name, functionality, type, location (the web-based software application and/or web page), time stamp, product, system, component. The list 504 (which may be sortable and/or subject to filtering) allows the user to select any or all of the listed changes for purposes of saving. The Save Changes interface 500 includes a Save button 506 (that can be activated to initiate saving of the selected changes) and a Cancel button 508 (that can be activated to cancel the saving routine and return to an appropriate location or page in the development environment). As explained in more detail below, the Save Changes interface 500 may also include a Discard Changes button 510 or link (that can be activated to initiate the discarding of selected changes).

Referring again to FIG. 9, the process 400 continues by recording selected and deselected changes, and by updating the displayed Save Changes interface as needed to reflect currently selected changes (task 408). If the currently selected changes are to be saved (the “Yes” branch of query task 410), then the process 400 continues by committing and implementing the selected changes in the defined production project that is associated with the development environment (task 412). After saving is complete, the process 400 resets the counter arrangement 308 to a currently appropriate state (task 414). For example, if all of the accumulated changes are saved, then all of the counters are reset to zero. As another example, if all but one change are saved, then two of the three counters are reset to zero, while the third counter is reset to a count of one (to reflect the unsaved change). At this point, an appropriate confirmation screen or page can be displayed, or the process 400 may return focus to an appropriate location or page in the development environment.

If the saving routine is cancelled without saving any of the accumulated changes (the “Yes” branch of query task 416), then the process 400 continues by exiting the saving routine without committing or implementing any of the changes to the production project (task 418). At this point, the counter arrangement 308 will maintain the currently accumulated counts, and will continue to be updated in response to further eligible changes made within the development environment.

In accordance with certain embodiments, the GUI project bar 304 may include or accommodate a feature that allows the user to discard changes that have been made within the development environment. In this regard, the GUI project bar 304 may include an activatable Discard Changes element (similar to the Save Changes element 330) or may otherwise provide access to a discard changes feature via a dynamic window, a dropdown menu, a GUI panel, or the like. Alternatively or additionally, a Discard Changes option may be provided in response to activation of the More Actions button 334. In some embodiments, the discard changes feature can be integrated with the save changes feature, such that the user can choose whether to selectively save or discard previously entered changes from a common page, window, or displayed GUI feature. See, for example, FIG. 10, which depicts a version of the Save Changes interface 500 that includes a GUI element to initiate discarding of entered changes (e.g., the Discard Change button 510).

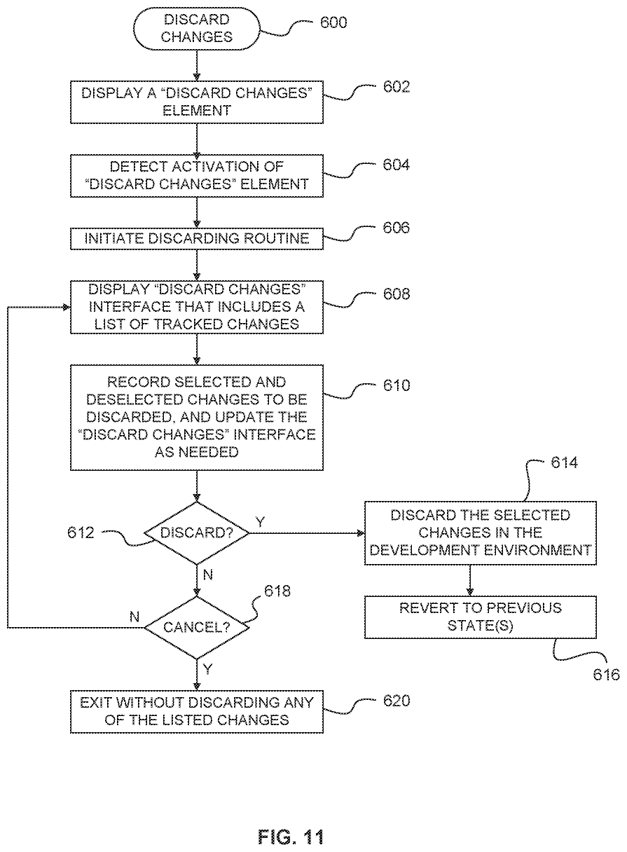

FIG. 11 is a flow chart that illustrates an exemplary embodiment of a discard changes process 600, which can be performed to discard changes made to one or more web-based software applications. The process 600 may begin by displaying a suitably formatted and arranged Discard Changes element in connection with the GUI project bar 304 or in connection with another GUI element or feature that can be launched or displayed in response to interaction with the GUI project bar (task 602). For example, the Discard Changes button 510 in FIG. 10 can be activated to initiate the discarding of at least one change tracked by the counter arrangement 308.

This description assumes that the process 600 detects activation of the Discard Changes element (task 604) and, in response to such detection, takes appropriate action to initiate a discarding routine or procedure (task 606). In certain embodiments, activation of the Discard Changes element initiates the display of a suitably formatted and arranged user interface (task 608). The user interface may include a list of entries corresponding to the changes tracked by the counter arrangement 308. Alternatively, activation of the Discard Changes element initiates the discarding routine for changes that have already been selected in the Save Changes interface 500. For such an alternative embodiment, tasks 602, 604, and 606 need not be performed if the Save Changes interface 500 is already displayed.

In some embodiments, a Discard Changes interface can be generated and displayed as a pop-up list or window, similar to the window 350 shown in FIG. 8. In certain embodiments, a Discard Changes interface is generated and displayed as a separate or overlay window to accommodate user interaction. For the implementation described here, the Save Changes interface 500 can be used as a user interface to initiate discarding of changes. In this regard, the same selectable list 504 is used to identify which changes (if any) are meant to be discarded. Accordingly the list 504 (which may be sortable and/or subject to filtering) allows the user to select any or all of the listed changes for purposes of discarding. The Discard Change button 510 can be activated to initiate discarding of the selected changes; the Cancel button 508 can be activated to cancel the discarding routine and return to an appropriate location or page in the development environment.

Referring again to FIG. 11, the process 600 continues by recording selected and deselected changes, and by updating the displayed user interface as needed to reflect currently selected changes (task 610). If the currently selected changes are to be discarded (the “Yes” branch of query task 612), then the process 600 continues by discarding the selected changes within the development environment (task 614). After discarding is complete, the process 600 reverts the web-based software applications in the development environment to the previous state(s) (task 616). In addition, the counter arrangement 308 is updated to reflect discarded changes. At this point, an appropriate confirmation screen or page can be displayed, or the process 600 may return focus to an appropriate location or page in the development environment.

If the discarding routine is cancelled without discarding any of the accumulated changes (the “Yes” branch of query task 618), then the process 600 continues by exiting the discarding routine without altering or undoing any of the previously recorded changes (task 620). At this point, the counter arrangement 308 will maintain the currently accumulated counts, and will continue to be updated in response to further eligible changes made within the development environment.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

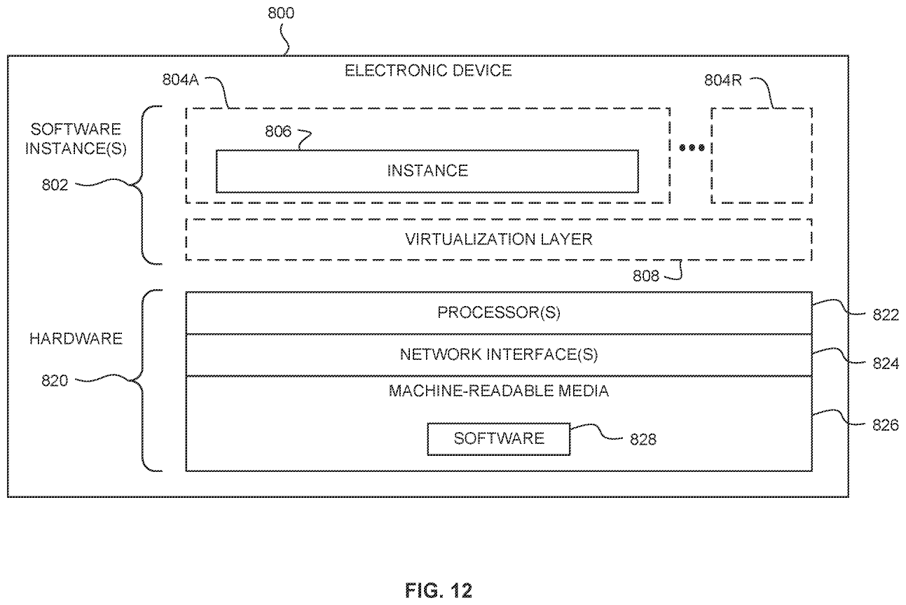

FIG. 12 is a simplified block diagram representation of an exemplary embodiment of an electronic device 800 according to some implementations. FIG. 12 includes hardware 820 including a set of one or more processor(s) 822, a set of one or more network interfaces 824 (wireless and/or wired), and machine-readable media 826 having stored therein software 828 (which includes instructions executable by the set of one or more processor(s) 822). The machine-readable media 826 may include non-transitory and/or transitory machine-readable media. Referring to FIG. 1, for example, the application server 102 and the client device 108 may be implemented using one or more electronic devices 800.

During operation, an instance of the software 828 (illustrated as instance 806 and referred to as a software instance; and in the more specific case of an application, as an application instance) is executed. In electronic devices that use compute virtualization, the set of one or more processor(s) 822 typically execute software to instantiate a virtualization layer 808 and one or more software container(s) 804A-804R (e.g., with operating system-level virtualization, the virtualization layer 808 may represent a container engine running on top of (or integrated into) an operating system, and it allows for the creation of multiple software containers 804A-804R (representing separate user space instances and also called virtualization engines, virtual private servers, or jails) that may each be used to execute a set of one or more applications; with full virtualization, the virtualization layer 808 represents a hypervisor (sometimes referred to as a virtual machine monitor (VMM)) or a hypervisor executing on top of a host operating system, and the software containers 804A-804R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 828 is executed within the software container 804A on the virtualization layer 808. In electronic devices where compute virtualization is not used, the instance 806 on top of a host operating system is executed on the “bare metal” electronic device 800. The instantiation of the instance 806, as well as the virtualization layer 808 and software containers 804A-804R if implemented, are collectively referred to as software instance(s) 802.

Alternative implementations of an electronic device may have numerous variations from that described above. For example, customized hardware and/or accelerators might also be used in an electronic device.

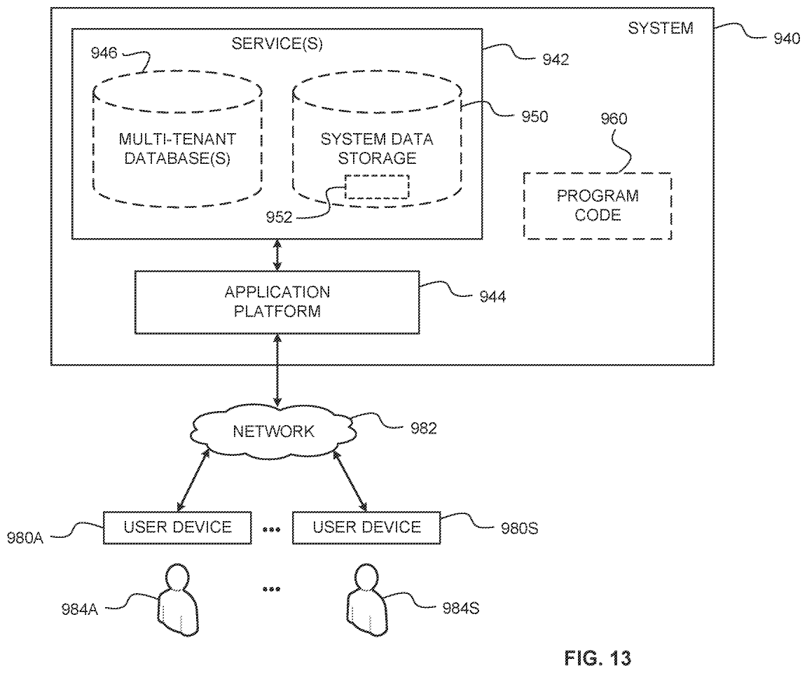

FIG. 13 is a simplified block diagram representation of an exemplary embodiment of a deployment environment according to some implementations. A system 940 includes hardware (e.g., a set of one or more server devices) and software to provide service(s) 942, which may include the web-based software applications 104, and one or more services or applications related to the monitoring, tracking, and saving of changes as described above. In some implementations the system 940 is in one or more datacenter(s). These datacenter(s) may be: 1) first party datacenter(s), which are datacenter(s) owned and/or operated by the same entity that provides and/or operates some or all of the software that provides the service(s) 942; and/or 2) third-party datacenter(s), which are datacenter(s) owned and/or operated by one or more different entities than the entity that provides the service(s) 942 (e.g., the different entities may host some or all of the software provided and/or operated by the entity that provides the service(s) 942). For example, third-party datacenters may be owned and/or operated by entities providing public cloud services.

The system 940 is coupled to user devices 980A-980S over a network 982. The service(s) 942 may be on-demand services that are made available to one or more of the users 984A-984S working for one or more entities other than the entity which owns and/or operates the on-demand services (those users sometimes referred to as outside users) so that those entities need not be concerned with building and/or maintaining a system, but instead may make use of the service(s) 942 when needed (e.g., when needed by the users 984A-984S). The service(s) 942 may communicate with each other and/or with one or more of the user devices 980A-980S via one or more APIs (e.g., a REST API). In some implementations, the user devices 980A-980S are operated by users 984A-984S, and each may be operated as a client device and/or a server device. In some implementations, one or more of the user devices 980A-980S are separate ones of the electronic device 800 or include one or more features of the electronic device 800.

In some implementations, one or more of the service(s) 942 may use one or more multi-tenant databases 946, as well as system data storage 950 for system data 952 accessible to system 940. In certain implementations, the system 940 includes a set of one or more servers that are running on server electronic devices and that are configured to handle requests for any authorized user associated with any tenant (there is no server affinity for a user and/or tenant to a specific server). The user devices 980A-980S communicate with the server(s) of system 940 to request and update tenant-level data and system-level data hosted by system 940, and in response the system 940 (e.g., one or more servers in system 940) automatically may generate one or more Structured Query Language (SQL) statements (e.g., one or more SQL queries) that are designed to access the desired information from the multi-tenant database(s) 946 and/or system data storage 950.

In some implementations, the service(s) 942 are implemented using virtual applications dynamically created at run time responsive to queries from the user devices 980A-980S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 960 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 944 includes an application setup mechanism that supports application developers' creation and management of applications, which may be saved as metadata by save routines (such as saving changes in the manner described above). Invocations to such applications, including the authorization service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 982 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 6th generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 940 and the user devices 980A-980S.

Each user device 980A-980S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 940. For example, the user interface device can be used to access data and applications hosted by system 940, and to perform searches on stored data, and otherwise allow one or more of users 984A-984S to interact with various GUI pages that may be presented to the one or more of users 984A-984S. User devices 980A-980S might communicate with system 940 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 980A-980S might include an HTTP client, commonly referred to as a “browser,” for sending and receiving HTTP messages to and from server(s) of system 940, thus allowing users 984A-984S of the user devices 980A-980S to access, process and view information, pages and applications available to it from system 940 over network 982.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

It should be understood that various aspects disclosed herein may be combined in different arrangements than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a hardware based computing device.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of tracking changes to software applications in a development environment, the method comprising:
permitting developer access to a plurality of different web-based software applications, in the development environment, wherein the plurality of different web-based software applications are part of a defined development project;
causing display of a graphical user interface (GUI) project bar on a display device, the GUI project bar comprising a counter arrangement that graphically tracks changes made to the plurality of different web-based software applications in the development environment; and
updating status of the counter arrangement in response to completion of an eligible change made to any of the plurality of different web-based software applications in the development environment, wherein status of the counter arrangement is updatable within the development environment to maintain at least one running count of eligible changes made to the plurality of different web-based software applications.

2. The method of claim 1, wherein:
the development environment supports display of the plurality of different web-based software applications via a plurality of different web pages; and
the method causes persistent display of the GUI project bar with the plurality of different web pages.

3. The method of claim 1, wherein:
the development environment supports display of the plurality of different web-based software applications via a plurality of different web pages; and
the method causes on-demand display of the GUI project bar with the plurality of different web pages.

4. The method of claim 1, wherein the counter arrangement comprises an addition counter that is updatable within the development environment to indicate a running count of additions made to the plurality of different web-based software applications.

5. The method of claim 1, wherein the counter arrangement comprises a modification counter that is updatable within the development environment to indicate a running count of modifications made to the plurality of different web-based software applications.

6. The method of claim 1, wherein the counter arrangement comprises a deletion counter that is updatable within the development environment to indicate a running count of deletions made to the plurality of different web-based software applications.

7. The method of claim 1, wherein:
the GUI project bar comprises an activatable Save Changes element that, when activated, initiates saving of at least one change tracked by the counter arrangement; and
saving of the at least one change causes implementation of the at least one change in the defined production project that is associated with the development environment.

8. The method of claim 7, further comprising:
causing, in response to activation of the Save Changes element, display of a Save Changes interface that includes a list of entries corresponding to changes tracked by the counter arrangement;
wherein at least some of the entries are selectable to identify changes to be implemented in the defined production project.

9. The method of claim 7, further comprising:
resetting the counter arrangement in response to activation of the Save Changes element.

10. The method of claim 1, further comprising:
causing display of an activatable Discard Changes element that, when activated, initiates discarding of at least one change tracked by the counter arrangement; and
discarding of the at least one change occurs within the development environment.

11. The method of claim 1, wherein:
the permitting step permits developer access to the plurality of different web-based software applications by multiple users; and
the counter arrangement is maintained and updated to graphically track changes made to the plurality of different web-based software applications by only one of the multiple users.

12. At least one non-transitory machine-readable storage medium that stores instructions executable by at least one processor, the instructions configurable to cause the at least one processor to perform a method of tracking changes to software applications in a development environment, the method comprising:
permitting developer access to a plurality of different web-based software applications, in the development environment, wherein the plurality of different web-based software applications are part of a defined development project;
causing display of a graphical user interface (GUI) project bar on a display device, the GUI project bar comprising a counter arrangement that graphically tracks changes made to the plurality of different web-based software applications in the development environment; and
updating status of the counter arrangement in response to completion of an eligible change made to any of the plurality of different web-based software applications in the development environment, wherein status of the counter arrangement is updatable within the development environment to maintain at least one running count of eligible changes made to the plurality of different web-based software applications.

13. The at least one non-transitory machine-readable storage medium of claim 12, wherein:
the development environment supports display of the plurality of different web-based software applications via a plurality of different web pages; and
the method performed by the at least one processor causes persistent display of the GUI project bar with the plurality of different web pages.

14. The at least one non-transitory machine-readable storage medium of claim 12, wherein the counter arrangement comprises:
an addition counter that is updatable within the development environment to indicate a running count of additions made to the plurality of different web-based software applications;
a modification counter that is updatable within the development environment to indicate a running count of modifications made to the plurality of different web-based software applications; and
a deletion counter that is updatable within the development environment to indicate a running count of deletions made to the plurality of different web-based software applications.

15. The at least one non-transitory machine-readable storage medium of claim 12, wherein:
the GUI project bar comprises an activatable Save Changes element that, when activated, initiates saving of at least one change tracked by the counter arrangement; and
saving of the at least one change causes implementation of the at least one change in the defined production project that is associated with the development environment.

16. The at least one non-transitory machine-readable storage medium of claim 15, wherein the method performed by the at least one processor further comprises:
causing, in response to activation of the Save Changes element, display of a Save Changes interface that includes a list of entries corresponding to changes tracked by the counter arrangement;
wherein at least some of the entries are selectable to identify changes to be implemented in the defined production project.

17. A computing system to track changes to software applications in a development environment, the computing system comprising:
at least one processor; and
at least one non-transitory machine-readable storage medium that stores instructions executable by the at least one processor, the instructions configurable to cause the at least one processor to perform a method, comprising:
permitting developer access to a plurality of different web-based software applications, in the development environment, wherein the plurality of different web-based software applications are part of a defined development project;
causing display of a graphical user interface (GUI) project bar on a display device, the GUI project bar comprising a counter arrangement that graphically tracks changes made to the plurality of different web-based software applications in the development environment; and
updating status of the counter arrangement in response to completion of an eligible change made to any of the plurality of different web-based software applications in the development environment, wherein status of the counter arrangement is updatable within the development environment to maintain at least one running count of eligible changes made to the plurality of different web-based software applications.

18. The computing system of claim 17, wherein:
the development environment supports display of the plurality of different web-based software applications via a plurality of different web pages; and
the method performed by the at least one processor causes persistent display of the GUI project bar with the plurality of different web pages.

19. The computing system of claim 17, wherein the counter arrangement comprises:
an addition counter that is updatable within the development environment to indicate a running count of additions made to the plurality of different web-based software applications;
a modification counter that is updatable within the development environment to indicate a running count of modifications made to the plurality of different web-based software applications; and
a deletion counter that is updatable within the development environment to indicate a running count of deletions made to the plurality of different web-based software applications.

20. The computing system of claim 17, wherein:
the GUI project bar comprises an activatable Save Changes element that, when activated, initiates saving of at least one change tracked by the counter arrangement; and
saving of the at least one change causes implementation of the at least one change in the defined production project that is associated with the development environment.

21. The computing system of claim 20, wherein the method performed by the at least one processor further comprises:
causing, in response to activation of the Save Changes element, display of a Save Changes interface that includes a list of entries corresponding to changes tracked by the counter arrangement;
wherein at least some of the entries are selectable to identify changes to be implemented in the defined production project.
